(19) United States
(12) Patent Application Publication
(10) Pub. No.: US 2025/0174376 A1
(43) Pub. Date: May 29, 2025

(54) TEMPERATURE SENSOR ELEMENT AND TEMPERATURE SENSOR

(71) Applicant: SHIBAURA ELECTRONICS CO., LTD., Saitama-shi, Saitama (JP)

(72) Inventor: Naohiro NIIZEKI, Saitama (JP)

(21) Appl. No.: 18/725,573

(22) PCT Filed: Jun. 23, 2023
(86) PCT No.: PCT/JP2023/023276

§ 371 Date: Jun. 28, 2024

(30) Foreign Application Priority Data
Jun. 27, 2022 (JP) 2022-102365

(51) Int. Cl. H01C 1/032; H01C 7/00

(52) U.S. Cl. CPC H01C 1/032; H01C 7/008

(57) ABSTRACT

[Solution] A temperature sensor element 1 according to the present invention includes: a heat sensitive body 11 of which electric resistance changes according to a temperature; a first coating layer 20 that covers a periphery of the heat sensitive body 11; a pair of lead-out wires 15 and 15 that are connected to the heat sensitive body 11 and also are led out in penetration through the first coating layer 20, toward a rear end side; a second coating layer 25 that covers a periphery of the pair of lead-out wires 15 and 15 which are led out in penetration through the first coating layer 20; and a third coating layer 30 that covers peripheries of the first coating layer 20 and the second coating layers 25 and 27. In the temperature sensor element 1, the second coating layer 25 is formed from a mixture of an oxygen-supplying oxide and glass.

### TECHNICAL FIELD

The present invention relates to a temperature sensor element that includes a heat sensitive body such as a thermistor, in which electrical characteristics change in response to a temperature change.

### BACKGROUND ART

A temperature sensor element includes: for example, a thermistor that is formed of an electroconductive oxide sintered body; a coating layer that coats a periphery of the thermistor; and a pair of lead-out wires that are connected to the thermistor and are led out in penetration through the coating layer.

When the temperature sensor element is used in a reducing gas atmosphere, the reducing gas intrudes into the thermistor through an interface between the coating layer and the lead-out wire. The thermistor is an oxide, and is accordingly reduced by a reducing gas that has intruded thereinto, which may decrease the temperature detection accuracy of the temperature sensor element.

In order to solve the above problem, in Patent Literature 1, a second coating layer is provided in addition to a first coating layer that coats the periphery of the thermistor, the second coating layer surrounding an extending portion of the lead-out wire on the outer surface of the first coating layer and being formed mainly containing an oxygen-supplying oxide. The oxygen-supplying oxide in Patent Literature 1 contains at least one oxide of Cr, Mn, Fe, Co, Ni, Ce and Pr. In Patent Literature 1, the second coating layer containing an oxygen-supplying oxide can suppress a reduction reaction under exposure of the thermistor to a strong reducing atmosphere even when a gap exists at an interface between the lead-out wire and the first coating layer.

### CITATION LIST

### Patent Literature

Patent Literature 1: JP 2016-12696 A

### SUMMARY OF INVENTION

### Technical Problem

However, in Patent Literature 1, there is a concern that an oxygen-supplying oxide may be depleted when the temperature sensor element is continuously used in a strong reducing atmosphere for a long time.

Then, an object of the present invention is to provide a temperature sensor element that can increase an oxygen supply and suppress a reduction reaction of a heat sensitive body.

### Solution to Problem

A temperature sensor element according to the present invention includes: a heat sensitive body of which the electric resistance changes according to a temperature; a plurality of coating layers that cover a periphery of the heat sensitive body; and a pair of lead-out wires that are connected to the heat sensitive body and also are led out in penetration through the coating layer, toward a rear end side.

In the temperature sensor element of the present invention, at least one of the coating layers is formed from a mixture of an oxygen-supplying oxide and glass.

The plurality of coating layers in the temperature sensor element of the present invention preferably includes: a first coating layer that is provided on an innermost side with respect to the heat sensitive body; a second coating layer that covers the periphery of the first coating layer, and covers the periphery of a pair of lead-out wires that are led out in penetration through the first coating layer; and a third coating layer that covers the periphery of the second coating layer. Any one of the first coating layer, the second coating layer, and the third coating layer is formed from the mixture of the oxygen-supplying oxide and the glass.

The oxygen-supplying oxide in the temperature sensor element of the present invention can be preferably an oxide of a transition metal element. The transition metal element can be preferably at least one of Cr, Mn, Fe, Ni, Ta, W and Cu.

The oxygen-supplying oxide in the temperature sensor element of the present invention can be preferably an oxide of a rare earth metal element. The rare earth metal element can be at least one of La, Ce, Pr, Nd, Sm, Eu, Gd, Tb, Yb and Lu.

In the temperature sensor element of the present invention, it is preferable that the first coating layer is composed of a first oxide powder, or a mixture of the first oxide powder and the glass, and the third coating layer is composed of a mixture of a third oxide powder and the glass.

The first oxide powder can be a powder for the thermistor that constitutes the heat sensitive body.

Furthermore, in the present invention, the second coating layer can be configured to cover the periphery of the pair of lead-out wires which are led out in penetration through the first coating layer, and also to cover the first coating layer in between the first coating layer and the third coating layer.

Furthermore, in the present invention, the second coating layer can be configured to limitedly cover the periphery of the pair of lead-out wires which are led out in penetration through the first coating layer so that the first coating layer and the third coating layer are in direct contact with each other.

Furthermore, the present invention can provide a temperature sensor equipped with the above temperature sensor element.

### Advantageous Effect of Invention

According to the present invention, a temperature sensor element is provided that can suppress a reduction reaction of a heat sensitive body through supply of oxygen from a second coating layer that is provided on a periphery of a lead-out wire and contains glass, even after a long time usage in a strong reducing atmosphere.

### BRIEF DESCRIPTION OF DRAWINGS

FIG. 1 shows a longitudinal cross-sectional view showing a schematic configuration of a thermistor element according to a first embodiment.

FIG. 2 shows a flow chart showing a procedure for manufacturing the thermistor element according to the first embodiment.

FIG. 3 shows a view showing a step of manufacturing the thermistor element according to the first embodiment, in addition to FIG. 2.

FIG. 4 shows a view showing a step of manufacturing the thermistor element according to the first embodiment, continued from FIG. 3.

FIG. 5 shows a longitudinal cross-sectional view showing a schematic configuration of a thermistor element according to a second embodiment.

FIG. 6 shows a view showing a step of manufacturing the thermistor element according to the second embodiment.

FIG. 7 is a graph showing a release curve of oxygen from Pr₆O₁₁ powder of an oxygen-supplying oxide, which is measured by a differential thermal balance-mass spectrometer (TG-MS).

FIG. 8 shows a graph showing a release curve of oxygen (O₂) from Tb₄O₇ powder of an oxygen-supplying oxide, which is measured by the differential thermal balance-mass spectrometer (TG-MS).

FIG. 9 shows a diagram illustrating a behavior of oxygen which is released from the second coating layer.

### DESCRIPTION OF EMBODIMENTS

Embodiments of the present invention will be described below with reference to the accompanying drawings.

A temperature sensor element 1 according to one embodiment of the present invention will be described with reference to the drawings.

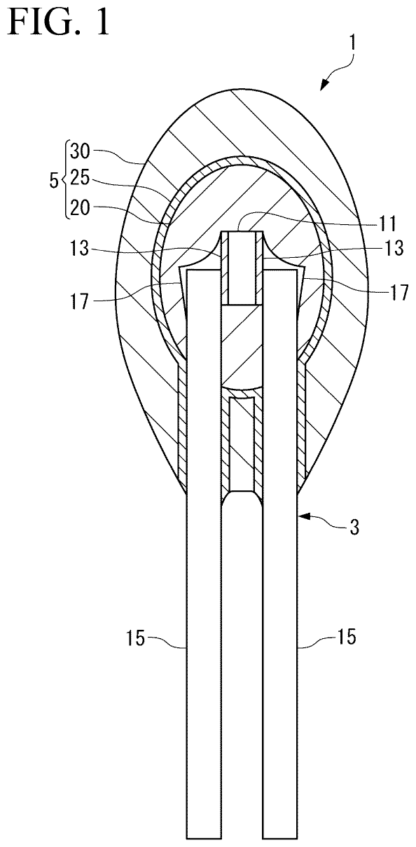

As shown in FIG. 1, the temperature sensor element 1 according to the present embodiment includes a thermistor element 3 and a coating layer 5. The thermistor element 3 includes: a heat sensitive body 11 of which the electric characteristic, for example, an electric resistance value, varies with a temperature; a pair of electrodes 13 and 13 which are formed on opposite side faces of the heat sensitive body 11; a pair of lead-out wires 15 and 15 which are connected to the electrodes 13 and 13, respectively; and connection electrodes 17 and 17 which electrically connect the electrodes 13 and 13 with the lead-out wires 15 and 15. In addition, the coating layer 5 includes: a first coating layer 20 that covers the heat sensitive body 11 and a part of the lead-out wires 15 and 15 together; a third coating layer 30 that covers the outside of the first coating layer 20; and a second coating layer 25 that is interposed between the first coating layer 20 and the third coating layer 30.

The temperature sensor element 1 is provided with the second coating layer 25 between the first coating layer 20 and the third coating layer 30, and the second coating layer 25 is made to have an oxygen supply effect which will be described in detail later. The temperature sensor element 1 can reduce a rate of change in the electric resistance value of the heat sensitive body 11 to a small value, in a reducing atmosphere, for example, an atmosphere containing hydrogen.

Note that, in some cases, the temperature sensor element 1 is used in a state of being accommodated in a protective pipe made from a metal excellent in heat resistance and oxidation resistance, such as stainless steel or Ni superalloy, though the specific description is omitted here.

Hereinafter, each element of the temperature sensor element 1 will be described, and then an operation and effects of the temperature sensor element 1 will be described.

### [Heat Sensitive Body 11]

A thermistor sintered body is used for the heat sensitive body 11. A thermistor is an abbreviation of a thermally sensitive resistor, and is a metal oxide that measures a temperature by utilizing its property that an electric resistance value changes according to a temperature.

The thermistor is classified into a negative temperature coefficient (NTC) thermistor and a positive temperature coefficient (PTC) thermistor, and any of the thermistors can be used in the present invention.

The oxide sintered body can be used for the heat sensitive body 11, which includes manganese oxide (Mn₃O₄) that has a spinel structure which is typical for an NTC thermistor, as a basic composition. The oxide sintered body can be used for the heat sensitive body 11, which has a composition of MxMn₃₋ₓO₄ that is obtained by addition of an M element (one or more of Ni, Co, Fe, Cu, Al and Cr) to the basic composition. Furthermore, one or more of V, B, Ba, Bi, Ca, La, Sb, Sr, Ti and Zr can be added.

In addition, the oxide sintered body can be used for the heat sensitive body 11, which includes a composite oxide having a perovskite structure that is typical for an NTC thermistor, for example, YCrO₃, as a basic composition. The sintered body most typical as the NTC thermistor has a Y₂O₃ phase and at least one of a Y(Cr, Mn) O₃ phase, a YCrO₃ phase and a YMnO₃ phase.

### [Method for Manufacturing Thermistor Sintered Body]

The heat sensitive body 11 formed of the thermistor sintered body is manufactured through the steps of: weighing raw material powders; mixing the raw material powders; drying the raw material powders; calcining the raw material powders; mixing and pulverizing the calcined raw material powders; drying and granulating the calcined raw material powders; and compacting and sintering the resultant. Each process will be described below while using a thermistor sintered body having the Y₂O₃ phase and the Y(Cr, Mn)O₃ phase, as an example.

### [Weighing of Raw Material Powder]

Raw material powders containing yttrium oxide (Y₂O₃) powder, chromium oxide (Cr₂O₃) powder, manganese oxide (MnO, Mn₂O₃, Mn₃O₄ or the like) powder and calcium carbonate (CaCO₃) powder are weighed so as to form the above-described chemical composition.

Note that, in the present embodiment, the powder is composed of a plurality of particles.

The Y₂O₃ powder contributes to the formation of the Y₂O₃ phase; and the Y₂O₃ powder, the Cr₂O₃ powder and the manganese oxide powder (Mn₃O₄ powder) contribute to the formation of the Y(Cr, Mn)O₃ phase. The CaCO₃ powder functions as a sintering aid, and in addition, dissolves in the Y(Cr, Mn)O₃ phase in a form of Ca, and contributes to lowering of the B constant.

The raw material powder to be used has a purity of 98% or higher, preferably 99% or higher, and more preferably 99.9% or higher, in order that a thermistor sintered body having high characteristics is obtained.

In addition, the particle size of the raw material powder is not limited as long as calcination proceeds, but can be selected from a range of 0.1 to 6.0 μm in terms of particle size (d50).

### [Mixing of Raw Material Powder and Ball Mill]

The Y₂O₃ powder, the Cr₂O₃ powder, the Mn₃O₄ powder and the CaCO₃ powder are each weighed by a predetermined amount, and are mixed. The mixing can be performed, for example, by a procedure of converting the mixed powder into a slurry state by addition of water, and mixing the slurry by a ball mill. For the mixing, a mixer other than a ball mill can also be used.

### [Drying of Raw Material Powder]

It is preferable to dry and granulate the slurry after the mixture, with a spray dryer or other equipment, and to form a mixed powder for calcination.

### [Calcination]

The mixed powder for calcination after drying is calcined. By the calcination, a calcined body having a composite structure of the Y₂O₃ phase and the Y(Cr, Mn)O₃ phase is obtained from the Y₂O₃ powder, the Cr₂O₃ powder, the Mn₃O₄ powder and the CaCO₃ powder.

In calcination, the mixed powder for calcination is charged into, for example, a crucible, and a temperature range of 800 to 1300° C. is maintained in the atmosphere. If the calcination temperature is lower than 800° C., the formation of the composite structure is insufficient, and if the calcination temperature exceeds 1300° C., there is a possibility that the density of the sintered body decreases and the stability of the resistance value decreases. Because of this, the holding temperature of the calcination is set in the range of 800 to 1300° C.

The holding time period in the calcination should be appropriately set according to the holding temperature, and a purpose of the calcination can be achieved by a holding time period of about 0.5 to 100 hours, in the case of the above temperature range.

### [Mixing, Pulverization and Ball Mill]

The powder after the calcination is mixed and pulverized. The mixing and pulverization can be performed by adding water to form a slurry and using a ball mill, as in the case before the calcination.

### [Drying and Granulation]

It is preferable to dry and granulate the powder after the pulverization, by a spray dryer or other equipment.

### [Compaction]

The granulated powder after the calcination is compacted into a predetermined shape.

For compaction, there can be used a press compaction with the use of a die, and in addition, a cold isostatic press (CIP: Cold Isostatic Press).

The higher the density of the compacted body is, the higher density the sintered body easily obtains; and accordingly, it is desirable to enhance the density of the compacted body as highly as possible. For this purpose, it is preferable to use the CIP which can obtain the high density.

### [Sintering]

Next, the obtained compacted body is sintered.

Sintering is performed by maintaining a temperature range of 1400 to 1650° C. in the atmosphere. If the sintering temperature is lower than 1400° C., the composite structure is not sufficiently formed, and if the temperature exceeds 1650° C., the sintered body is melted or causes a reaction with a crucible for the sintering or the like. A holding time period in the sintering should be appropriately set according to a holding temperature, and a dense sintered body can be obtained with a holding time period of about 0.5 to 200 hours, in the case of the above temperature range.

It is preferable for the obtained thermistor sintered body to be subjected to annealing so as to stabilize its thermistor characteristics. Annealing is performed by maintaining the temperature at, for example, 1000° C. in the atmosphere.

### [Electrodes 13 and 13 and Connection Electrodes 17 and 17]

As shown in FIG. 1, the electrodes 13 and 13 are formed in a film shape on the whole areas of both front and back surfaces of the heat sensitive body 11 having a plate shape, respectively. The electrodes 13 and 13 are composed of platinum (Pt) or another noble metal.

The electrodes 13 and 13 are formed as thick films or thin films. The electrodes 13 and 13 of the thick films are formed in such a manner that a paste that has been produced by mixing of platinum powder and an organic binder is applied onto both front and back surfaces of the thermistor sintered body, the paste is dried, and then the resultant is sintered. In addition, the thin film electrode can be formed by vacuum deposition or sputtering.

The heat sensitive body 11 on which the electrodes 13 and 13 are formed is worked into a predetermined dimension.

The connection electrodes 17 and 17 are composed of metal films which are formed on the surfaces of the electrodes 13 and 13, respectively. The connection electrodes 17 and 17 are also composed of platinum (Pt) or another noble metal.

### [Lead-Out Wires 15 and 15]

As shown in FIG. 1, one end side of each of the lead-out wires 15 and 15 is electrically and mechanically connected to the respective electrodes 13 and 13 via the respective connection electrode 17 and 17. The other end sides of the lead-out wires 15 and 15 are connected to an external detection circuit of which the illustration is omitted. The lead-out wires 15 and 15 are composed of a wire material that is formed of, for example, platinum or an alloy of platinum and iridium (Ir), each having heat resistance. It is presumed that the hydrogen which reduces the heat sensitive body 11 reaches the heat sensitive body 11 through the lead-out wires 15 and 15.

The lead-out wires 15 and 15 are connected to the electrodes 13 and 13 in the following way.

Paste containing platinum powder which forms connection electrodes 17 and 17 is applied to one end side of each of the lead-out wires 15 and 15, in advance. The platinum paste is dried in a state in which the sides of the lead-out wires 15 and 15 coated with the platinum paste are brought into contact with the electrodes 13 and 13, respectively, and then the platinum powder is sintered.

### [First Coating Layer 20]

Next, the first coating layer 20 will be described.

It is a main function of the first coating layer 20 to become a buffer material for alleviating a stress generated by thermal expansion of the third coating layer 30 from being directly applied to the heat sensitive body 11. In other words, the first coating layer 20 receives the thermal stress from the third coating layer 30.

In addition, the first coating layer 20 fixes connection portions between the heat sensitive body 11 and the lead-out wires 15 and 15, and thereby realizes stable electrical and mechanical connections.

The first coating layer 20 according to the present embodiment is formed of a mixture of glass and oxide powder (first oxide powder), in one preferable embodiment.

In the first coating layer 20, the glass functions as a binding agent that binds the oxide powders to each other and allows the first coating layer 20 to maintain its shape.

A ratio of the glass to the oxide powder is not limited as long as the desired coefficient of linear expansion is obtained and the glass functions as the binding agent.

As the glass constituting the first coating layer 20, one or both of crystalline glass and amorphous glass can be used, but it is preferable to use crystalline glass which is stable at high temperature. As the crystalline glass, for example, a composition can be applied which includes 30 to 60 wt % of SiO₂, 10 to 30 wt % of Cao, 5 to 25 wt % of MgO, and 0 to 15 wt % of Al₂O₃.

Examples of the oxide powders constituting the first coating layer 20 include aluminum oxide (Al₂O₃), magnesium oxide (MgO), calcium oxide (CaO), yttrium oxide (Y₂O₃), and zirconium oxide (ZrO₂). In addition, as this oxide powder, a thermistor powder constituting the heat sensitive body 11 can be used.

As the thermistor powder, a powder can be used which has a composition equivalent to that of the thermistor sintered body constituting the heat sensitive body 11. The equivalent composition means that both of the thermistor powders contained in the heat sensitive body 11 and in the first inner layer form have the above-described chemical composition of Cr, Mn, Ca and Y, excluding oxygen, which is included in a composition range of Cr: 3 to 15 mol %, Mn: 5 to 15 mol %, and Ca: 0.5 to 8 mol %. The case is also included where the thermistor powder and the thermistor sintered body constituting the heat sensitive body 11 have the same composition.

The first coating layer 20 according to the present embodiment is allowed to be formed of only the oxide powder, in another preferable embodiment.

### [Third Coating Layer 30]

Next, the third coating layer 30 will be described. It is a main function of the third coating layer 30 to provide airtightness for hermetically sealing of the heat sensitive body 11 from the surrounding atmosphere. The third coating layer 30 imparts a mechanical strength for protecting the heat sensitive body 11 from external force.

The third coating layer 30 can be composed of a glass similar to that of the first coating layer 20. The third coating layer 30 may also be formed of a mixture of the glass similar to that of the first coating layer 20 and an oxide powder (third oxide powder). A usable oxide powder includes one or more of aluminum oxide (Al₂O₃), magnesium oxide (MgO), yttrium oxide (Y₂O₃), calcium oxide (CaO), zirconium oxide (ZrO₂), strontium oxide (SrO), titanium oxide (TiO) and lanthanum oxide (La₂O₃).

The third coating layer 30 according to the present embodiment is formed of a mixture of the glass similar to that of the first coating layer 20 and the oxide powder. However, the third coating layer 30 contains a large amount of glass, as compared to the first coating layer 20.

The third coating layer 30 can obtain a necessary thickness and state by one layer of the third coating layer 30, which is formed by one time of operation, but the third coating layer 30 can also be formed to have a plurality of layers. When the third coating layer 30 is formed of a plurality of layers, each layer may have an equal thickness or an unequal thickness to the others.

In addition, the third coating layer 30 can also contain an oxide supplying powder. In this case, the oxide supplying powder may be contained in only one layer of the plurality of layers, or the oxide supplying powder may be contained in all the layers. It can be said that the third coating layer 30 containing the oxide supplying powder has the same configuration as the second coating layer 25.

### [Second Coating Layer 25]

Next, the second coating layer 25 will be described.

The second coating layer 25 is provided between the first coating layer 20 and the third coating layer 30, and covers the first coating layer 20 and also covers the outer circumferential surface of the lead-out wire 15 which is led out from the first coating layer 20. The periphery of the second coating layer 25 covering the lead-out wire 15 is covered with the third coating layer 30.

The second coating layer 25 releases oxygen while the temperature sensor element 1 is used in a high-temperature region containing hydrogen, makes the oxygen react with hydrogen, and thereby suppresses the reduction of the heat sensitive body 11 by the hydrogen. Though the detail will be described later, it is the oxygen-supplying oxide that directly releases oxygen, and the oxygen which is released from the oxygen-supplying oxide propagates through the glass and suppresses a reduction reaction in the heat sensitive body 11, which is caused by hydrogen that intrudes into the heat sensitive body 11 through the lead-out wire 15.

The second coating layer 25 is formed from a glass similar to that of the first coating layer 20 and an oxygen-supplying oxide. Usable oxygen-supplying oxides include an oxide of a transition metal element, and an oxide of a rare earth metal element.

As the transition metal element, at least one of Cr, Mn, Fe, Ni, Co, Ta, W and Cu is preferable. As the rare earth metal element, at least one of La, Ce, Pr, Nd, Sm, Eu, Gd, Tb, Yb and Lu is preferable.

A content of the oxygen-supplying oxide powder in the second coating layer 25 is selected from a range of 0.5 to 30% by mass, and the balance is glass. If the content is less than 0.5% by mass, an effect by oxygen supply is insufficient in some cases, and if the content exceeds 30% by mass, the glass impairs the sealing property and airtightness, and facilitates the reducing gas to intrude into the heat sensitive body. The content of the oxygen-supplying oxide powder is preferably in a range of 1 to 25% by mass, is more preferably in a range of 2 to 20% by mass, and is further preferably in a range of 5 to 15% by mass.

### [Method for Manufacturing Temperature Sensor Element 1]

Next, a method for manufacturing the temperature sensor element 1 will be described.

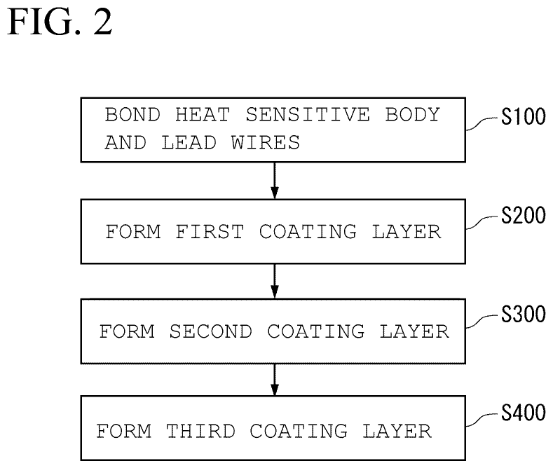

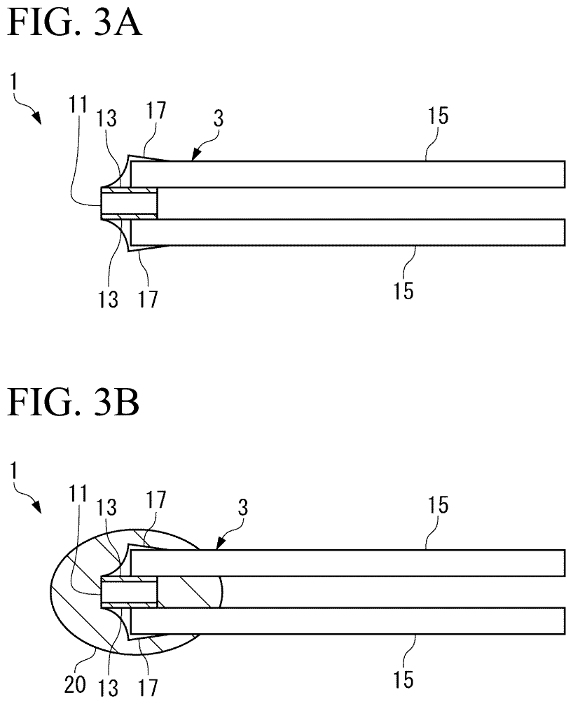

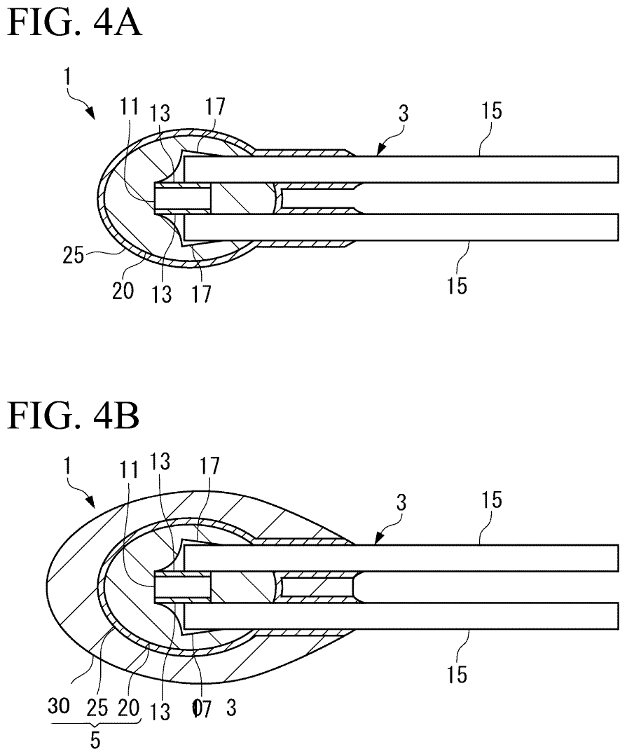

As shown in FIG. 2 and FIG. 3, the temperature sensor element 1 is manufactured through the steps of: bonding the heat sensitive body 11 and the lead-out wires 15 and 15 (S100 in FIG. 2, and FIG. 3A); forming the first coating layer 20 on the bonded heat sensitive body 11 (S200 in FIG. 2, and FIG. 3B); forming the second coating layer 25 on a periphery of the first coating layer 20 (S300 in FIG. 2, and FIG. 4A); and forming the third coating layer 30 on peripheries of the first coating layer 20 and the second coating layer 25 (S400 in FIG. 2, and FIG. 4B).

For the first coating layer 20, a paste is prepared in which, for example, the previously described oxide powder, preferably, the thermistor powder and the crystalline glass powder are mixed with a solvent. After the paste has been formed on the heat sensitive body 11, the paste is dried, then the glass component is subjected to firing treatment at, for example, 1200° C.; and thereby the first coating layer 20 is formed. In the first coating layer 20 obtained in this way, the thermistor powder is bonded to the fired glass, and particles constituting the thermistor powder are dispersed in the glass. The same applies to the second coating layer 25 and the third coating layer 30.

For forming the paste on the heat sensitive body 11, a dipping method is suitably applied in which the thermistor element is dipped in the paste from the heat sensitive body 11 side to a predetermined range of the lead-out wire 15, and the resultant is pulled out from the paste. The same applies to the second coating layer 25 and the third coating layer 30.

When the first coating layer 20 is formed of a plurality of layers, dipping is performed a plurality of times; and then the resultant is dried, and is subjected to firing treatment, for example, at 1200° C. In addition, when the first coating layer 20 is formed of a plurality of layers, a boundary between the adjacent coating layers can be visually recognized, and the adjacent coating layers are bonded to each other with a force of a degree that can secure the function of the first coating layer 20. This is also applied to the second coating layer 25 and the third coating layer 30 in the same manner.

For the second coating layer 25, a paste is prepared in which a powder of an oxygen-supplying oxide and a crystalline glass powder are mixed with a solvent. After the paste has been formed on the first coating layer 20, the paste is dried, then the glass component is subjected to firing treatment, for example, at 1200° C., and the second coating layer 25 is formed.

Furthermore, as for the third coating layer as well, the third coating layer 30 is formed on the second coating layer 25 with the use of the glass paste for the outer layer, which has been prepared by mixing of the oxide powder, the glass powder and the solvent in the same way as in the above description.

### Second Embodiment

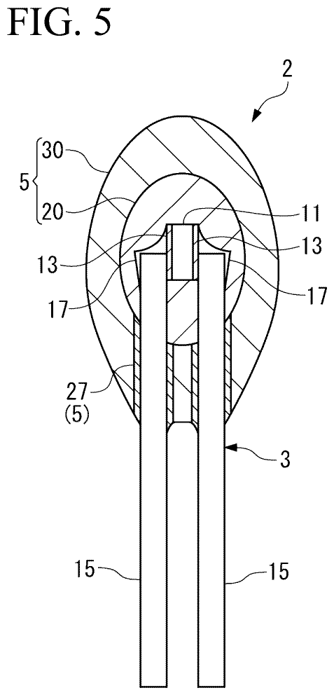

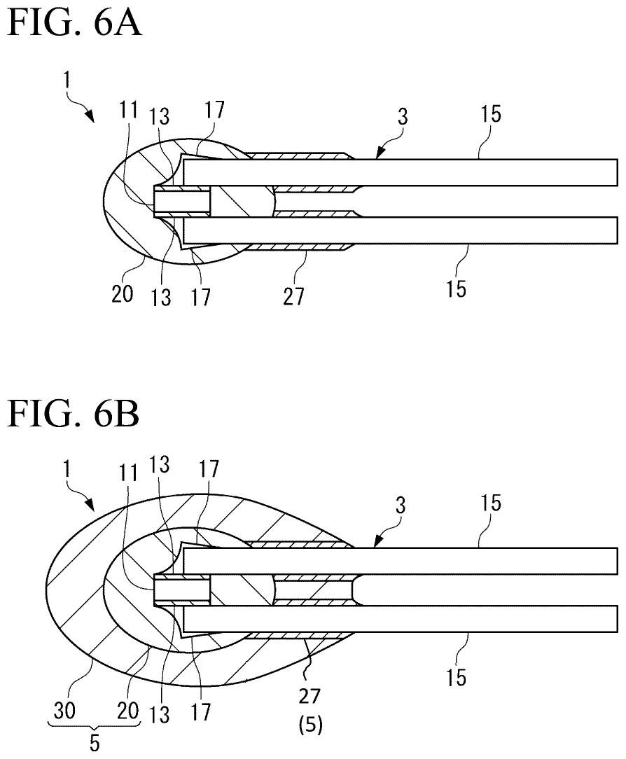

Next, a temperature sensor element 2 according to a second embodiment will be described with reference to FIG. 5 and FIG. 6.

When the temperature sensor element 2 will be described in comparison with the temperature sensor element 1, as shown in FIG. 5, the second coating layer 27 does not cover the first coating layer 20, and covers the periphery of the lead-out wires 15 and 15. In other words, in the temperature sensor element 2, the first coating layer 20 and the third coating layer 30 are in direct contact with each other, and the second coating layer 27 is provided only on the outer peripheries of the lead-out wires 15 and 15. Accordingly, the cross section of a portion at which the second coating layer 27 is provided has a structure in which the lead-out wire 15, the second coating layer 27, and the third coating layer 30 are arranged in this order from the inside or the center, similarly to that of the first embodiment. Except for this point, as shown in FIG. 6, the temperature sensor element 2 is manufactured through the same steps as those of the temperature sensor element 1.

The temperature sensor element 2 having the above cross-sectional structure around the lead-out wire 15 can enhance the reduction resistance, similarly to that of the temperature sensor element 1 of the first embodiment.

It is difficult to form the second coating layer 27 by dipping. For example, the second coating layer 27 is formed in such a manner that a paste is applied to the region by a liquid quantitative discharge device which is referred to as a dispenser, and the paste is then dried and fired.

### First Example

Next, one example of the present invention will be described on the basis of specific Example.

The temperature sensor element 1 was manufactured that included the first coating layer 20, the second coating layer 25 and the third coating layer 30, which would be described below, and a rate of change in a resistance value was measured. The results are shown in Table 1.

### [Manufacture of Heat Sensitive Body 11]

Raw material powders having the following particle sizes (d50) were prepared of which the mixing ratios were shown in the following, and a heat sensitive body 11 was manufactured according to the above-described steps. The calcination was performed under conditions of 1300° C. for 24 hours, and the sintering was performed under conditions of 1500° C. for 24 hours, both in the atmosphere.
Y₂O₃: 79.5 mol %, particle size: 0.1 μm
Cr₂O₃: 8.5 mol %, particle size: 2.0 μm
CaCO₃: 3.5 mol %, particle size: 2.0 μm
Mn₃O₄: 8.5 mol %, particle size: 5.0 μm

The electrode 13, the lead-out wire 15 and the connection electrode 17 were all formed from platinum (pt), and the thermistor element 3 was produced by the procedure described in the embodiment.

### [Formation of Coating Layer]

On the thermistor element 3 described above, the first coating layer 20, the second coating layer 25 and the third coating layer 30 were formed.

For the first coating layer 20, crystalline glass was used as glass, and a thermistor powder which had the same composition as that of the heat sensitive body 11 was used. A mass ratio of the crystalline glass to the thermistor powder was controlled to 20:80. In addition, for a paste for the first coating layer 20, an organic binder was used as a binder, and a single precursor layer was formed by dipping. After that, the precursor layer was dried and subjected to heat treatment for firing, and the first coating layer 20 according to the Example was formed.

The crystalline glass and the powder of an oxygen-supplying oxide were prepared, and thereby the second coating layer 25 was produced. A mass ratio of the crystalline glass to the oxygen-supplying oxide powder is as shown in Table 1 and Table 2. For comparison, an yttrium oxide powder was prepared, and an example of the second coating layer 25 was also produced in which a mass ratio of the crystalline glass to the yttrium oxide powder was controlled to 80:20. Note that Table 1 shows examples of oxides of transition metal elements, and Table 2 shows examples of oxides of rare earth metal elements. Note that yttrium oxide does not release oxygen even when having been heated, and accordingly does not correspond to the oxygen-supplying oxide of the present invention.

For the third coating layer 30, crystalline glass and Y₂O₃ as the third oxide powder were used. A mass ratio of the crystalline glass to the Y₂O₃ of the third oxide powder is 80:20.

The second coating layer 25 and the third coating layer 30 were formed in the following way. The second coating layer 25 and the third coating layer 30 according to the Example were formed in such a manner that a precursor layer of the second coating layer 25 was formed by dipping a thermistor element 3 in a paste for the second coating layer 25, a precursor layer of the third coating layer 30 was formed by dipping the resultant in a paste for the third coating layer 30, and then, the resultant was dried and subjected to heat treatment for firing.

Rates of changes in electric resistance values were measured under the following conditions, with the use of the temperature sensor elements (Sample Nos. 1 to 19) shown in Table 1 and Table 2. The measurement results are shown in Table 1 and Table 2.

### [First Measurement Condition]

Holding temperature: 900° C.
Atmosphere: hydrogen 5 vol. %+nitrogen 95 vol. %
Holding time period: 10 hours
Resistance measurement temperature: 25° C.

### [Second Measurement Condition]

The rate of change in the electric resistance value was measured under the second measurement conditions which were the same as the first measurement conditions except that the holding temperature was 1050° C.

TABLE 1

| | Second coating | | | | | |
|---|---|---|---|---|---|---|
| | layer 25 [mass %] | | | | Resistance change | |
| Sample | | | Oxygen- | | rate [%], 10 hrs | |
| No. | Glass | Y₂0₃ | supplying oxide | | 900° C. | 1050° C. |
| 1 | 80 | 20 | — | — | 77.05 | 420.82 |
| 2 | 74.8 | 18.7 | Pt0 | 6.5 | 10.22 | 16.61 |
| 3 | 80 | 2 | Cr₂0₃ | 18 | 22.30 | 298.52 |
| 4 | 80 | 2 | Mn₃0₄ | 18 | 75.72 | 386.93 |
| 5 | 80 | 0 | Fe₂0₃ | 20 | 7.26 | 47.75 |
| 6 | 80 | 0 | Co0 | 20 | 27.46 | 213.43 |
| 7 | 80 | 0 | Ni0 | 20 | 10.75 | 325.22 |
| 8 | 80 | 0 | Ta₂0₃ | 20 | 43.20 | 187.04 |
| 9 | 80 | 18 | W0₃ | 2 | 67.11 | 220.58 |

TABLE 2

| | Second coating | | | | | |
|---|---|---|---|---|---|---|
| | layer 25 [mass %] | | | | Resistance change | |
| Sample | | | Oxygen- | | rate [%], 10 hrs | |
| No. | Glass | Y₂0₃ | supplying oxide | | 900° C. | 1050° C. |
| 1 | 80 | 20 | — | — | 77.05 | 420.87 |
| 2 | 74.8 | 18.7 | Pt0 | 6.5 | 10.22 | 16.61 |
| 10 | 80 | 0 | La₂0₃ | 20 | 44.10 | 254.89 |
| 11 | 80 | 0 | Ce0₂ | 20 | 6.42 | 203.99 |
| 12 | 80 | 0 | Pr₆0₁₁ | 20 | 2.23 | 11.21 |
| 13 | 80 | 0 | Nd₂0₃ | 20 | 46.32 | 234.05 |
| 14 | 80 | 0 | Sm₂0₃ | 20 | 46.02 | 216.46 |
| 15 | 80 | 18 | Eu₂0₃ | 2 | 12.51 | 64.12 |
| 16 | 80 | 0 | Gd₂0₃ | 20 | 38.86 | 632.21 |
| 17 | 80 | 0 | Tb₄0₇ | 20 | 1.17 | 50.81 |
| 18 | 80 | 18 | Yb₂0₃ | 2 | 28.99 | 57.28 |
| 19 | 80 | 18 | Lu₂0₃ | 2 | 86.22 | 356.84 |

It is understood from Table 1 and Table 2 that the rate of change in the electric resistance value in high temperature ranges of 900° C. and 1050° C. can be reduced by the second coating layer 25 that contains glass and also an oxygen-supplying oxide, and that the reduction resistance enhances.

There is the case where the tendency of the rate of change in the electric resistance value is different between 900° C. and 1050° C., and this is considered to be because there is a difference in a degree of oxygen release depending on a temperature. As a result, there is the case where the rate of change in the electric resistance value at 900° C. is small, and on the other hand, a rate of change in the electric resistance value at 1050° C. is large; and there is also the reverse case. An example of the former includes cerium oxide (sample No. 11), and an example of the latter includes europium oxide (sample No. 18).

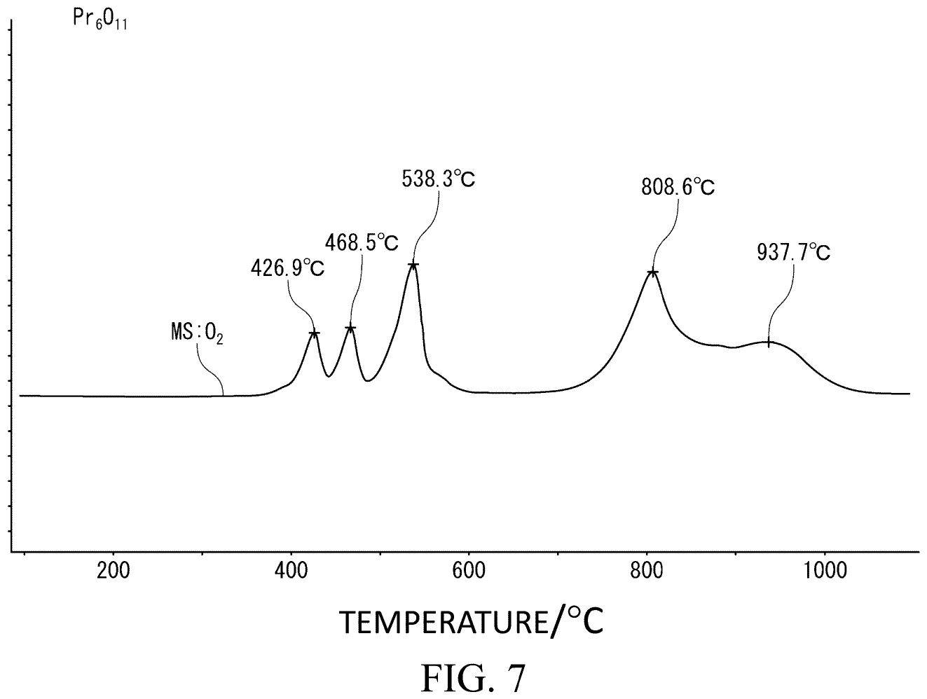

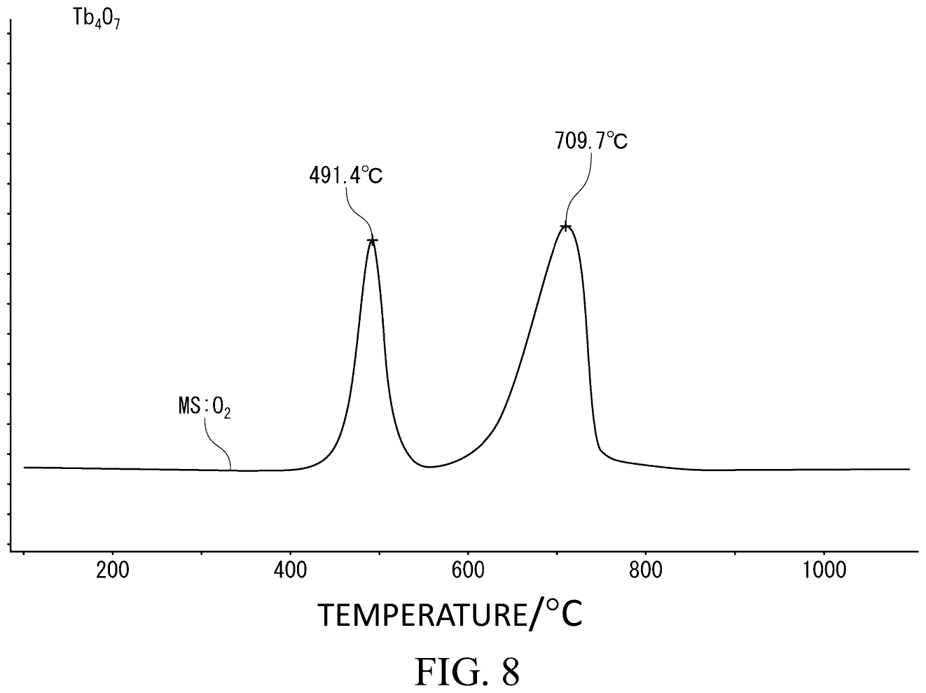

The reason why there is a difference in the degree of oxygen release according to the temperature will be described with reference to FIG. 7 and FIG. 8.

FIG. 7 is a graph showing a relationship between a temperature and an amount of released oxygen (O₂), by TG-MS of praseodymium oxide (Pr₆O₁₁); and FIG. 8 is a graph showing a relationship between a temperature and an amount of released oxygen (O₂), by TG-MS of terbium oxide (Tb₄O₇).

From FIG. 7 and FIG. 8, it is understood that a behavior of releasing oxygen varies depending on the type of oxygen-supplying oxide. For example, praseodymium oxide can release oxygen over a wider temperature range than terbium oxide. In addition, the terbium oxide releases most of oxygen in a temperature range of 750° C. or lower. Thus, the behavior of oxygen release varies depending on the temperature, which is considered to be the factor that the tendency of the rate of change in resistance differs depending on the temperature of 900° C. or 1050° C.

### Second Example

A temperature sensor element (sample No. 22) was produced in the same way as in the first Example, except that copper oxide (CuO) shown in Table 3 was used as the oxygen-supplying oxide in the second coating layer 25, and was used for measurement of the rate of change in the electric resistance value under the first measurement condition and the second measurement condition of the first Example. The measurement results are shown in Table 3.

TABLE 3

| | | | | | Resistance change rate [%] | | | | | |
|---|---|---|---|---|---|---|---|---|---|---|
| Sample | Second coating layer 25 [mass %] | | | | 900° C. | | | 1050° C. | | |
| No. | Glass | Y₂0₃ | Oxygen-supplying oxide | | 5 hr | 10 hr | 72 hr | 5 hr | 10 hr | 72 hr |
| 1 | 80 | 20 | — | — | 3.99 | 77.05 | >10000 | — | — | — |
| 22 | 80 | 0 | Cu0 | 20 | −0.15 | −1.17 | −4.66 | −4.81 | −4.90 | 6.71 |

From Table 3, it is understood that when copper oxide (CuO) acting as the oxygen-supplying oxide is contained in the second coating layer 25 containing glass, the rate of change in the electric resistance value can be reduced in the high temperature range of 900° C. and 1050° C., and the reduction resistance enhances.

Copper oxide is known as a catalyst element, and the content of oxygen therein is small in such a way that oxygen is 1 compared to 1 for metal (Cu). However, the glass is composed of an oxide, and accordingly, it is understood that the copper oxide acquires oxygen from the glass and supplies oxygen to the reducing gas and thereby remarkably enhances the reduction resistance.

### Third Example

Temperature sensor elements (sample Nos. 23 to 30) were produced in the same way as in the first Example, except that a powder of oxygen-supplying oxide was added also to the third coating layer 30 in addition to the second coating layer 25, and were used for measurement of the rate of change in the electric resistance value under the first measurement condition and the second measurement condition of the first Example. The measurement results are shown in Table 4.

TABLE 4

| | | | | | | | | | Resistance change rate [%], 900° C. × 10 Hrs | |
|---|---|---|---|---|---|---|---|---|---|---|
| Sample | Second coating layer 25 [mass %] | | | | Third coating layer 30 [mass %] | | | | Second coating | Second coating layer 25 + |
| No. | Glass | Y₂0₃ | Oxygen-supplying oxide | | Glass | Y₂0₃ | Oxygen-supplying oxide | | layer 25 only | Third coating layer 30 |
| 1 | 80 | 20 | — | | 80 | 20 | — | | 77.05 | — |
| 23 | 90 | 0 | Ni0 | 10 | 90 | 0 | Ni0 | 10 | 10.75 | 19.07 |
| 24 | 90 | 0 | Fe₂0₃ | 10 | 90 | 0 | Fe₂0₃ | 10 | 7.26 | 8.56 |
| 25 | 90 | 0 | Tb₄0₇ | 10 | 90 | 0 | Tb₄0₇ | 10 | — | 0.26 |
| 26 | 90 | 0 | Eu₂0₃ | 10 | 90 | 0 | Eu₂0₃ | 10 | — | 10.96 |
| 27 | 90 | 0 | Nd₂0₃ | 10 | 90 | 0 | Nd₂0₃ | 10 | — | 22.04 |
| 28 | 90 | 0 | Yb₂0₃ | 10 | 90 | 0 | Yb₂0₃ | 10 | — | 29.81 |
| 29 | 90 | 0 | Sm₂0₃ | 10 | 90 | 0 | Sm₂0₃ | 10 | — | 24.83 |
| 30 | 90 | 0 | Gd₂0₃ | 10 | 90 | 0 | Gd₂0₃ | 10 | — | 61.44 |

From Table 4, it is understood that when the oxygen-supplying oxide is contained also in the third coating layer 30 in addition to that the oxygen-supplying oxide is contained in the second coating layer 25 containing glass, the rate of change in the electric resistance value can be reduced in the high temperature range of 900° C. and 1050° C., and the reduction resistance enhances.

### [Behavior of Oxygen Supply in Second Coating Layer 25]

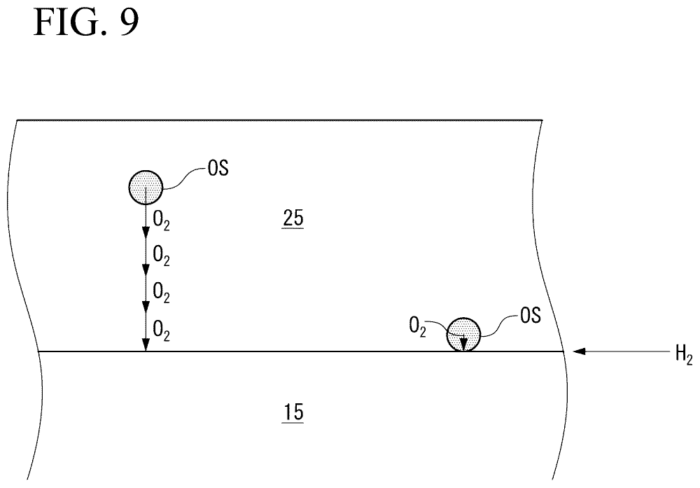

Next, a behavior of oxygen supply in the second coating layer 25, which the inventors infer, will be described with reference to FIG. 9.

As shown in FIG. 9, the particles OS of the oxygen-supplying oxide dispersed in the glass in the second coating layer 25 may be in contact with the lead-out wire 15, or may be separated from the lead-out wire 15. Note that FIG. 9 shows only these two examples.

When the particle OS is in contact with the lead-out wire 15, oxygen is directly supplied to the periphery of the lead-out wire 15. When the particle OS is separated from the lead-out wire 15, the oxygen (Oz) that is released from the particle OS is not directly supplied to the periphery of the lead-out wire 15 through the glass. The oxygen that has been released from the particle OS is bonded to silicon oxide (SiO₂) or calcium oxide (CaO) constituting the glass in the periphery, and thereby, the oxygen is supplied when the glass is attacked by the reducing gas. Glass has airtightness, and accordingly oxygen is not exceptional. However, when the glass is exposed to a gas that impairs chemical stability, and oxygen is supplied from the particle OS, the glass maintains the airtightness while maintaining the performance of the glass, and thereby endures the deterioration of the performance under a high-temperature reducing gas.

In addition, when an excessive amount of reducing gas has intruded thereinto, a chemical bond of the glass is broken. When the airtightness of the glass is broken, the intrusion of the reducing gas usually proceeds at an accelerated rate, but when the particle OS exists, the oxygen is not supplied to the glass but is released to the periphery. The oxygen released to the periphery is further bonded to silicon oxide or calcium oxide constituting the glass in the periphery, and thereby, excess oxygen is released to the periphery. In addition, it is possible to excessively increase the amount of the particles to be added, so as to intentionally create a state of decreasing the airtightness performance of the glass, which is caused by excessive reducing gas; or to arbitrarily change the chemical properties of the glass by simultaneously adding copper oxide CuO, even in the case where the amount of the particles to be added is proper, and to control a range of oxygen supplied to the periphery.

It is inferred that when the maintenance of the airtightness performance by the supply of oxygen to the glass starting from the particle of the oxygen-supplying oxide and the release of oxygen are repeated in this way, oxygen is supplied to the periphery of the lead-out wire 15 even in the case where the particle is separated from the lead-out wire 15.

In the present embodiment, the case where the oxygen-supplying oxide powder is contained in the second coating layer 25 is described as an example, but the present invention is not limited thereto. For example, the oxygen-supplying oxide powder can be contained in at least one layer of the first coating layer 20, the second coating layer 25 and the third coating layer 30.

Accordingly, for example, the oxygen-supplying oxide powder may be contained in all of the first coating layer 20, the second coating layer 25 and the third coating layer 30. Furthermore, for example, it is also acceptable to compose the second coating layer 25 from a plurality of layers, and make each layer contain the oxygen-supplying oxide powder, and further adjust the amount of the oxygen-supplying oxide powder in each layer. In this way, it is possible to adjust the reduction resistance by adjusting the layer in which the oxygen-supplying oxide powder is contained, and the content of the oxygen-supplying oxide powder. In addition, as is clear from the above description, the description that the coating layers in the present invention are plural includes a case where there are a plurality of layers which have different features such as the first coating layer 20, the second coating layer 25 and the third coating layer 30, and in addition, a case where there are plurality of layers having the same feature as in the example of the second coating layer 25 described above.

In the above, the preferable embodiments of the present invention have been described, but the configurations described in the above embodiments can be selected or replaced with other configurations, as long as the gist of the invention does not deviate.

### REFERENCE SIGNS LIST

1 Temperature sensor element
3 Thermistor element
5 Coating layer
11 Heat sensitive body
13 Electrode
15 Lead-out wire
17 Connection electrode
20 First coating layer
25 Second coating layer
30 Third coating layer

1. A temperature sensor element comprising:
a heat sensitive body of which electric resistance changes according to a temperature;
a plurality of coating layers that cover a periphery of the heat sensitive body; and
a pair of lead-out wires that are connected to the heat sensitive body and also are led out in penetration through the coating layer, toward a rear end side, wherein
at least one of the coating layers is formed from a mixture of an oxygen-supplying oxide and glass.

2. The temperature sensor element according to claim 1, wherein
the plurality of coating layers comprises:
a first coating layer that is provided on an innermost side with respect to the heat sensitive body;
a second coating layer that covers a periphery of the first coating layer, and covers a periphery of the pair of lead-out wires that are led out in penetration through the first coating layer; and
a third coating layer that covers a periphery of the second coating layer, wherein
any one of the first coating layer, the second coating layer, and the third coating layer is formed from the mixture of the oxygen-supplying oxide and the glass.

3. The temperature sensor element according to claim 1, wherein
the oxygen-supplying oxide is formed of an oxide of a transition metal element.

4. The temperature sensor element according to claim 3, wherein
the transition metal element is at least one of Cr, Mn, Fe, Ni, Co, Ta, W and Cu.

5. The temperature sensor element according to claim 1, wherein
the oxygen-supplying oxide is formed of an oxide of a rare earth metal element.

6. The temperature sensor element according to claim 5, wherein
the rare earth metal element is at least one of La, Ce, Pr, Nd, Sm, Eu, Gd, Tb, Yb and Lu.

7. The temperature sensor element according to claim 2, wherein
the first coating layer comprises a first oxide powder, or a mixture of the first oxide powder and the glass, and
the third coating layer comprises a mixture of a third oxide powder and the glass.

8. The temperature sensor element according to claim 7, wherein
the first oxide powder is formed of a powder of thermistor constituting the heat sensitive body.

9. The temperature sensor element according to claim 2, wherein
the second coating layer covers the periphery of the pair of lead-out wires that are led out in penetration through the first coating layer, and covers the first coating layer in between the first coating layer and the third coating layer.

10. The temperature sensor element according to claim 2, wherein
the second coating layer limitedly covers the periphery of the pair of lead-out wires that are led out in penetration through the first coating layer, and
the first coating layer and the third coating layer are in direct contact with each other.

11. A temperature sensor comprising the temperature sensor element according to claim 1.

12. The temperature sensor element according to claim 2, wherein
the oxygen-supplying oxide is formed of an oxide of a transition metal element.

13. The temperature sensor element according to claim 2, wherein
the oxygen-supplying oxide is formed of an oxide of a rare earth metal element.

14. A temperature sensor comprising the temperature sensor element according to claim 2.
